(19) United States
(12) Patent Application Publication
(10) Pub. No.: US 2017/0250547 A1
(43) Pub. Date: Aug. 31, 2017

(54) SUPERCAPACITOR SUPPLY BANK, CHARGING SYSTEM AND METHODS

(71) Applicant: 906 Engineering Corporation, Marquette, MI (US)

(72) Inventors: Peter Carl Menze, Marquette, MI (US); Stephen Robert Lang, Ishpeming, MI (US); Matthew Menze, Duluth, MN (US)

(21) Appl. No.: 15/442,646

(22) Filed: Feb. 25, 2017

Related U.S. Application Data
(60) Provisional application No. 62/341,595, filed on May 25, 2016.
(60) Provisional application No. 62/300,750, filed on Feb. 26, 2016.

(51) Int. Cl. H02J 7/00

(52) U.S. Cl. CPC H02J 7/0019; H02J 7/0026; H02J 7/345

(57) ABSTRACT

A supercapacitor power unit electrically coupled to a load. The supercapacitor power unit comprises a supercapacitor bank and charging system comprising at least two supercapacitor cells and an electrical conductor. The electrical conductor couples in series at least two supercapacitors to form a supercapacitor bank. A supercapacitor bank separator circuit interrupts the conductor in a charge mode to form at least two supercapacitor bank parts. The two supercapacitor bank parts form a supercapacitor bank in a load mode when the bank separator circuit is closed. The system includes a supercapacitor charge system electrically coupled separately to each said at least two supercapacitor bank parts for charging each supercapacitor bank part. Using this configuration, a supercapacitor bank is fully recharged without need of expensive electronics to boost the voltage from a local charging system.

This Non-Provisional patent application claims priority to U.S. Provisional Patent Application No. 62/341,595 filed May 25, 2016, and U.S. Provisional Patent Application No. 62/300,750 filed Feb. 26, 2016, the entire disclosures of which are hereby incorporated by reference and relied upon.

### BACKGROUND OF THE INVENTION

Field of the Invention

The invention relates generally to supercapacitor supply systems, and more particularly to supercapacitor supply systems, charging of these systems, and methods for their use and control.

Description of Related Art

Supercapacitors are high-capacity electrochemical capacitors with much higher capacitance values than other capacitors although with lower voltage limits. Supercapacitors, also known as ultracapacitors, typically store 10 to 100 times more energy per unit volume than electrolytic capacitors. Supercapacitors can charge and release charge much faster than batteries while enduring a far greater number of charging and discharging cycles then rechargeable batteries. Batteries typically perform sufficiently as a source of continuous low power; however they have the disadvantage of charging and discharging slowly. Batteries are also poor at handling peak power demands.

Rather than long term energy storage applications, supercapacitors are often found in applications requiring rapidly repeating charge-discharge cycles. They are used in applications such as regenerative braking in cars, buses, cranes, or elevators. Supercapacitors are also used in hybrid buses to increase acceleration. In some forms, supercapacitors are used to power trams and may be recharged in as little as 30 seconds by energy supplied between the rails of the tram to provide power for the tram to travel several kilometers before quick recharge. Supercapacitors are also used to supplement batteries in starter systems of diesel railroad locomotives from energy recovered from braking. Other uses of supercapacitors include motor racing, hybrid electric, street lights, medical, aviation, military, and providing energy to data centers between power failures and initiation of backup power systems.

Individual supercapacitors come in a range of voltages and have a wide range of applications. For more demanding applications, individual supercapacitors are often linked together in series and/or parallel to provide the power demands of a particular function. For example, a bank of supercapacitors may be linked in series to provide a high voltage and high current source that a standard power system is able to provide. In some applications, this high powered source is used to complement battery power to provide reliable burst power such as at ignition when starting a truck.

In some applications, banked supercapacitors are joined to provide an output voltage that is different than the immediately available charging system. For example, supercapacitors may be linked to create a bank of capacitors capable of powering a 16.2 volt hydraulic lift system on a truck. The truck's 12V charging system is incapable of recharging the 16.2V capacitor bank without specialized circuitry to step up the output voltage. In systems of the prior art, this step up voltage circuitry significantly adds to the cost of a banked supercapacitor system. The most common method of stepping up the voltage is through the use of expensive inductors that often push the cost of supercapacitor systems out of reach for many applications.

What is needed are novel systems and methods for increasing the power that can be supplied from otherwise underpowered electrical power systems. In addition, what is needed are systems and methods to provide low cost recharging to these systems. These power systems include those found on mobile vehicles and other machinery. In addition, needed are methods and apparatus for creating banked supercapacitor systems with a cost effective means for recharging the bank then resupplying the power to the load application.

### BRIEF SUMMARY OF THE INVENTION

Disclosed is a novel modular supercapacitor power unit (SPU) comprising a supercapacitor bank (SCB) and a supercapacitor charging and control system (SCS) and examples of various embodiments thereof.

In one form, a supercapacitor power unit comprises a plurality of supercapacitors electrically coupled in series using electrical conductors to form a supercapacitor bank (SCB).

In one form, a supercapacitor power unit comprises a supercapacitor power unit enclosure for housing and protection of supercapacitors stored therein.

In one form, a supercapacitor power unit comprises one or more of supercapacitor charging system electronics and control system electronics.

In one form, a SPU comprises a power unit enclosure for housing supercapacitors used in a supercapacitor bank (SCB) system and may also house associated electronics that are part of a supercapacitor charging and control system (SCS).

In one form a SCB and SCS are housed in separate enclosures.

In one form, a SPU may comprise a positive and negative connection terminal for electrical connection (of a load for example) to a SCB.

In one form, electrical conductors such as wires and printed circuit boards are utilized to electrically couple electronic components.

In one form, a SPU may also include positive and negative charge terminals for input of a remote charge current in communication with an SCS.

In one form, a supercapacitor bank (SCB) comprises a collection of supercapacitors utilized within a supercapacitor power unit (SPU).

In one form, a supercapacitor bank (SCB) is formed of a plurality of super capacitor bank parts (SBP). Each SBP comprises one or more supercapacitors electrically coupled in series, parallel, or series and parallel.

In one form, a supercapacitor bank part (SBP) comprises individual supercapacitors electrically coupled in series.

In one form, each supercapacitor electrically coupled in series may include a plurality of supercapacitors electrically coupled in parallel to it.

In one operational configuration, two or more SBPs are electrically connected in series to create a SCB. Output voltage of the supercapacitor bank SCB is a sum of the voltage output by a series of connected SBPs.

In one form, output voltage from a SCB is within a voltage range in which an electrically coupled load requires for proper operation.

In one form, a supercapacitor power unit utilizes a novel inter-part switching device within a SCB and charging and control system.

In one form, an inter-part switch electrically couples and uncouples one or more SBPs.

In one form, an inter-part switching device dividing a SCB is in the form of a bank separator circuit.

In one form, an inter-part switching device dividing a SCB is in the form of a bank separator circuit electronically controlled by a micro-controller.

In one form, an inter-part switching device dividing an SCB is manually operated by a user.

In one form, in a load mode an inter-part switching device is electrically closed providing full voltage of a SCB to a load.

In one form, in a charge mode an inter-part switching device is electrically open thereby electrically isolating individual SBPs making up a SCB. An isolated SBP has a voltage capacity that is only a portion of the voltage of a fully charged SCB voltage output.

In one form, an inter-part switch may have more than one throw.

In one form, an inter-part switch is a double throw switch.

In one form, an inter-part switch comprises a primary throw and a secondary throw.

In one form, a secondary throw is electrically coupled to ground.

In one form, an inter-part switch used between two or more SBPs is in the form of an electro-mechanical switch such as a relay.

In one form, an inter-part switch used between two or more SBPs is in the form of a solid state switch.

In one form, an inter-part switch used between two or more SBPs is in the form of a MOSFET transistor solid state switch (mechanical switches are illustrated in some drawings for simplification purposes but various forms of switches may be used).

In one form, inter-part switches and other switches within an associated supercapacitor charging and control system (SCS) are controlled by one or more microcontrollers.

In one form, various electronic switches within a supercapacitor charging and control system are mechanically controlled or analog.

In one form, various electronic switches within a supercapacitor charging and control system are controlled using a combination of two or more these methods. For example, some of the switches are controlled by a microcontroller and others controlled mechanically.

In one form, successful system operation of an SPU is dependent on the correct timing of the opening and closing of the system's switches.

In one form, the electrical state of components of a supercapacitor power unit (SPU) are monitored by current sensors, voltage sensors, or a combination of current and voltage sensors.

In one form, current sensors within a supercapacitor charging and control system are one or more of closed-loop and open loop.

In one form, current sensors within a supercapacitor charging and control system may assume a variety of different forms such as one or more of, Hall Effect, inductive, resistor, fiber optic, and fluxgate.

In one form, a supercapacitor bank and charging and control system comprises a current sensor detecting switching of a load between on (whereby the load my draw current from an associated supercapacitor bank) and off (whereby the load cannot draw from the associated supercapacitor bank).

In one form, a supercapacitor bank and charging system comprises an alternate ground path used for sensing.

In one form, a supercapacitor bank and charging system comprises an alternate ground path that is a high ohm path sensing a load without activating a load.

In one form, a supercapacitor bank and charging system comprises one or more sensors determining the presence of an external load without identifying a type of load.

In one form, a supercapacitor bank and charging system wherein said one or more of said sensors are positioned before a high current output terminal of said supercapacitor bank.

In one form, voltage sensors used within a supercapacitor charging and control system are in the form of a circuit.

In one form, information from voltage sensors within a supercapacitor charging and control system provide electrical information to a SCS system.

In one form, information from voltage sensors within a supercapacitor charging and control system provide electrical information to a user for the regulation of components such as switches or other components such as those regulating levels of charge current.

In one form, information from voltage sensors within a supercapacitor charging and control system report their information in the form of an electrical signal to a microcontroller for regulation of one or more electrical components within the system.

In one form, information from voltage sensors within a supercapacitor charging and control system report their information to components using analog logic methods of control.

In one form, one or more of voltage sensors and current sensors provide electronic signal information required for control of switches controlling flow of current towards a load from a SCB.

In one form, one or more of voltage sensors and current sensors provide electronic signal information for controlling the electrical separation or joining of the SBPs.

In one form, one or more of voltage sensors and current sensors provide electronic signal information for control management of voltage regulators that operate to adjust current output of individual charging circuits servicing each SBP to optimize charging of a SCB. For example, if a charging system is capable of an output of X amps then the system may initially provide X/2 amps to each of two SBP. However if the one or more of voltage sensors and current sensors sense one SBP is fully charged, the charging system may then direct a voltage regulator in the charging system to provide a full X amps to the uncharged SBP. Alternatively, in the event one or more of voltage sensors and current sensors indicate lagging recharge of one or more SBPs, a voltage regulator may be directed to provide a greater share of amps (i.e. 3X/4) to the lagging SBP and a smaller share of amps (i.e. X/4) to the fuller SBP in order to have all SBPs complete charging generally simultaneously. This optimization between two or more charging circuit modules results in efficient recharging of each SBP so the SCB can be ready to supply a load in the shortest amount of time.

In one form, it is preferred, although not required, that at the end of a charge cycle that each SBP is charged to generally an equal voltage output.

In one form, voltage sensors within a supercapacitor charging and control system circuit monitors for differences in voltage between SBPs. If voltage differences between SBPs exceed a predefined maximum limit, an inter-part switch may be prevented from closing and thereby combining the SBPs in a SCB. For example, a microcontroller may be programmed to control the opening or closing of one or more inter-part switch based a predefined voltage or current discrepancy between one or more SBPs. Closing of an inter-part switch between SBPs will cause current to flow therebetween and equalize the voltage between SBPs. It is therefore preferred that large discrepancies in voltage between SBPs are avoided so to not incur destructive levels of current flowing across an inter-part switch.

In one form, a supercapacitor bank (SCB) is separated by a bank separator into two or more supercapacitor bank parts (SBPs) wherein each bank part is charged independently by an isolated power supply.

In one form, said isolated power supply is a DC-DC conversion power supply.

In one form, said isolated power supply is a transformer having a 1:1 input to output voltage.

In one form, said power supply transformer comprises secondary windings that can be electrically uncoupled from said load.

In one form, a supercapacitor bank and charging system comprises a transformer having secondary windings that can be electrically uncoupled from a load.

In one form, said isolated DC-DC conversion power supply has one or more of a diode and MOSFET to prevent reverse voltage and current flow.

In one form, a supercapacitor bank charging system comprises a transformer having multiple secondary windings.

In one form, each secondary windings of an isolated transformer is electrically coupled to a separate supercapacitor bank part for charging each supercapacitor bank part.

In one form, each supercapacitor bank part (SBP) is charged independently by an isolated power supply wherein each charging circuit further comprises its own ground path to prevent conflict with each other.

In one form, a supercapacitor bank and charging and control system wherein a supercapacitor bank part has one or more of a sensor and a trigger on its high current output for detection of one or more of a demand and load.

In one form, a supercapacitor bank and charging and control system comprises a pull-up resistor that is pulled down upon a demand from an external load.

In one form, a supercapacitor bank and charging and control system comprises a pull-up resistor that is pulled down upon a demand from an external load and further comprising a diode to prevent a pull up voltage from changing when a load is being powered.

In one form, a supercapacitor bank and charging and control system comprises a switchable ground circuit providing a ground path for a supercapacitor charging system when a supercapacitor bank is divided into said at least two supercapacitor bank parts.

In one form, a supercapacitor bank and charging and control system comprises a supercapacitor bank separator circuit using one or more temperature inputs to control opening and closing of said supercapacitor bank separator circuit.

In one form, a supercapacitor bank and charging and control system comprising a supercapacitor balancing circuit.

In one form, a supercapacitor bank and charging and control system comprises a supercapacitor balancing circuit wherein said balancing circuit is passively adjustable to supercapacitor bank parts being electrically divided and combined.

In one form, a supercapacitor bank and charging and control system comprises a supercapacitor balancing circuit wherein said balancing circuit is actively adjustable to supercapacitor bank parts being electrically divided and combined.

In one form, a supercapacitor bank and charging and control system comprises a microcontroller controlling a supercapacitor balancing circuit based on input signals from bank separation circuitry.

In one form, a supercapacitor bank and charging and control system comprises a microcontroller wherein the microcontroller sends an output signal to a digital potentiometer circuit to adjust one or more of voltage output and current output in a supercapacitor charge system charging at least two or more supercapacitor bank parts.

In one form, a supercapacitor bank and charging and control system comprises a microcontroller which uses one or more of a resistor ladder and a network to adjust one or more of voltage output and current output of a supercapacitor bank part charging circuit.

In one form, a supercapacitor bank and charging and control system comprising a microcontroller receiving at least one input signal from a sensor electrically coupled to the supercapacitor bank wherein said microcontroller effectuates said bank separator to alternately electronically divide said supercapacitor bank into supercapacitor bank parts and combine said supercapacitor bank parts into a supercapacitor bank.

In one form, a supercapacitor bank and charging and control system comprising a microcontroller wherein the microcontroller receives at least one input signal from a sensor electrically coupled to said supercapacitor bank and wherein said microcontroller effectuates based on the input signal said supercapacitor charge system to output variable levels of current to one or more supercapacitor bank parts for optimizing charging rates.

In one form, a supercapacitor bank and charging and control system comprises a circuit monitoring one or more of voltage and current of a supercapacitor bank part for triggering said supercapacitor charge system to add a charging current to said supercapacitor bank part thereby charging the supercapacitor bank.

In one form, a supercapacitor bank and charging and control system comprises a circuit monitoring one or more of voltage and current of a supercapacitor bank part for triggering said supercapacitor charge system to add a boosting current to said supercapacitor bank part thereby boosting said supercapacitor bank when said supercapacitor bank is discharging to a load.

In one form, a supercapacitor bank and charging and control system having a supercapacitor bank separator circuit further comprises a high ohm path across the supercapacitor bank separator for testing voltage levels of said supercapacitor bank.

In one form, a supercapacitor bank and charging and control system having a supercapacitor bank separator circuit further comprises a high ohm path across the supercapacitor bank separator for testing voltage levels of said supercapacitor bank and wherein said high ohm path is switchable between an on and off position for sensing and testing.

In one form, a supercapacitor bank is separated by a bank separator into two or more supercapacitor bank parts (SBP). A supercapacitor charging system utilizes a single power supply having independent coil windings with associated circuits for charging each of two or more supercapacitor bank parts.

In one form, one or more supercapacitor charging circuits comprises a protection circuit for guarding the one or more of the supercapacitor charging circuits from reverse voltage and current.

In one form, a one or more supercapacitor charging circuit comprises a protection circuit wherein the protection circuit includes the use of one or more of a back to back MOSFETs and a diode.

In one form, one or more fuses are introduced into a supercapacitor charging and control system circuitry for protection of one or more bank separators. The fuse utilized may be of a resettable type, an automatic resettable type, or a combination of resettable and automatic resettable.

In one form, a method utilizing a supercapacitor bank (SCB) to power a high current device comprises opening a circuit between a supercapacitor bank and a load of the high current device. Then electrically dividing the SCB into two or more supercapacitor bank part (SBP) portions using an inter-part switching device such as a bank separator circuit wherein voltage output of each SBP is lower than the SCB. Having a lower voltage capacity than the SCB, each SBP is then charged at this lower voltage to generally full voltage capacity. Each SBP is then electrically rejoined in series by the use of one or more inter-part switches to reform a recharged supercapacitor bank used for powering a high current load.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 a graphic illustrating a supercapacitor bank from the prior art wherein supercapacitor cells are electrically coupled in series but unable to fully charge by a lower voltage charging system;

FIG. 2 is graphic illustrating an embodiment of the invention using an inter-parts switch to divide a supercapacitor bank into two or more supercapacitor bank parts then fully charging each supercapacitor bank individually by a lower charge voltage;

FIG. 3 is a graphic illustrating a general system view of an embodiment of a supercapacitor power unit housed within a supercapacitor system enclosure;

FIG. 4 is an electrical schematic of one embodiment of a SCB separable into two or more SBPs;

FIG. 5 is an electrical schematic of the embodiment of FIG. 4 with a current sensor;

FIG. 6 is an electrical schematic of an embodiment of a SCB supplying a load and with an integrated charging circuit and current sensors;

FIG. 7 is an electrical schematic of an embodiment of a SCB supplying a load and illustrating potential locations of various current and voltage sensors (charging circuits removed);

FIG. 8 is an electrical schematic of one embodiment of a voltage sensing circuit;

FIG. 9 is an electrical schematic of one embodiment of a charging circuit suited for charging a supercapacitor bank;

FIG. 10 is an electrical schematic illustrating yet another embodiment of a dividable SCB with associated charging circuits and load and relays;

FIG. 11 is an electrical schematic illustrating an embodiment of a dividable SCB similar to FIG. 10 but using a combination of MOSFETs and relays;

FIG. 12 schematically illustrates a preferred embodiment of a supercapacitor power unit;

FIG. 13 replicates FIG. 12 illustration and highlighting in bold a high current path for powering a load when a supercapacitor bank is in a load mode;

FIG. 14 replicates FIG. 12 highlighting in bold line a charging path of a first supercapacitor charging circuit and a second supercapacitor charging circuit to one or more supercapacitor banks parts;

FIG. 15 illustrates an electrical schematic view of a bank separator dividing a supercapacitor bank into a first supercapacitor bank part and a second supercapacitor bank part;

FIG. 15A is a graphic illustrating various switches in a SCB circuit during various modes;

FIG. 15B is a graphic illustrating one embodiment of a step wise method of splitting then fully recharging a supercapacitor bank after discharge;

FIG. 16 replicates FIG. 12 with schematic highlight of a high current path for discharge of a supercapacitor bank to a load and utilization of a charge circuit as a booster;

FIG. 17 schematically replicates FIG. 12 and illustrating an alternative embodiment of a supercapacitor power unit (SPU) using an alternate ground path for sensing;

FIG. 18 is an electrical schematic illustrating one embodiment of a current sensor circuit;

FIG. 19 is an electrical schematic of one embodiment of a demand trigger having a pull-up resistor;

FIG. 20 are electrical circuit schematics illustrating alternate ground paths for sensing purposes;

FIGS. 21 and 22 are electrical schematics illustrating embodiments of charging circuits that may be used to charge a supercapacitor bank;

FIG. 23 is an electrical schematic of one embodiment of a bank separator circuit that may be used in accordance with a supercapacitor power unit to separate a SCB in supercapacitor bank parts;

FIG. 24 is an illustration of one embodiment of a supercapacitor bank part comprising three pairs of supercapacitors whereby each supercapacitor in a pair is electrically connected in parallel and said 3 pairs are connected in series;

FIG. 25 illustrates a second supercapacitor bank part;

FIG. 26 illustrates an alternative embodiment of a pair of supercapacitor bank parts with individual grounding circuits extending from a plurality of coils;

FIG. 27 illustrates another alternative embodiment of a pair of supercapacitor bank parts with individual grounded charging circuits extending from a single coil.

### DETAILED DESCRIPTION OF SELECTED EMBODIMENTS OF THE INVENTION

Selected embodiments of the invention will now be described with reference to the Figures, wherein like numerals reflect like elements throughout and wherein letters assigned to like numerals distinguish between various embodiments (i.e. 44A, 44B, 44C, 44D, etc). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

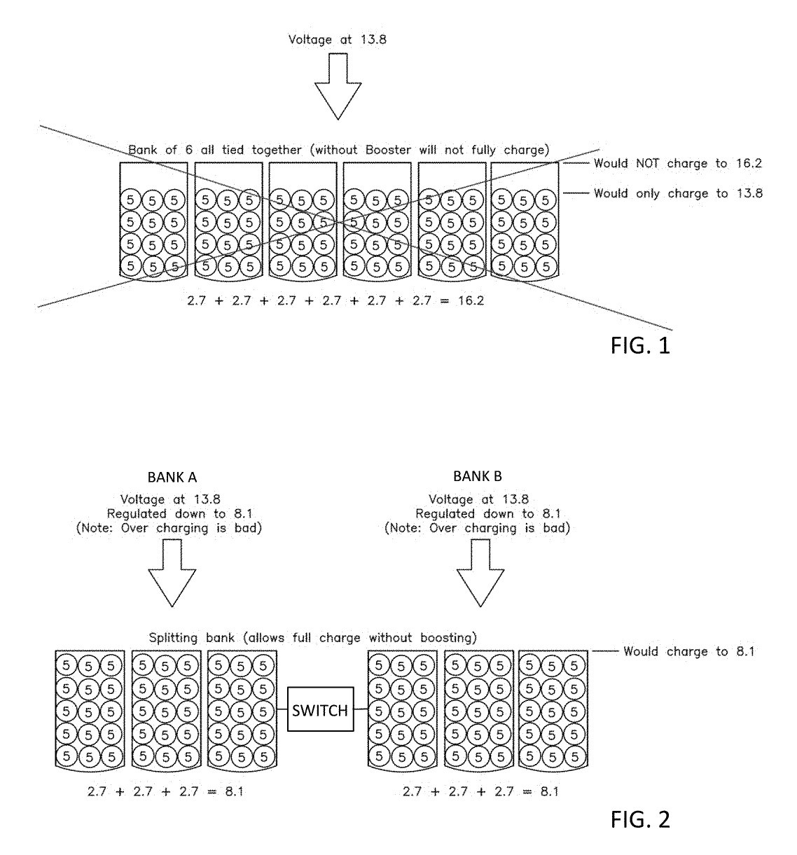

FIG. 1 illustrates a type of supercapacitor bank from the prior art whereby individual supercapacitors are electrically connected in series to produce a total voltage output of a supercapacitor bank. In this illustrative example, each of six 2.7V supercapacitors are connected in series to produce a combined 16.2V (volt) output. Assuming recharge of the supercapacitor bank relies on a local charging system such as a truck's typical 12V system which produces 13.8Vpeak, the supercapacitor bank could only charge to 13.8V and not to a full 16.2V. This system would be non-functional for its intended purpose of powering a load requiring 16.2V and thus is illustrated with the system crossed out. FIG. 2 however illustrates a supercapacitor bank with key differences. At least one switch is placed within the series connection joining the supercapacitors together. With switch opened, the SCB is split into two or more SBPs. In the FIG. 2 illustration, a SCB is split into two identical SBPs of 8.1V each. Current from a truck's 12V charging system is easily and cost effectively stepped down to 8.1V and separately applied to recharge each SBP until each SBP is fully charged at 8.1V. A switch dividing BANK A and BANK B is then closed. Full recharge of the SCB in this example, is accomplished without the need for expensive electronics to boost the voltage from a local charging system.

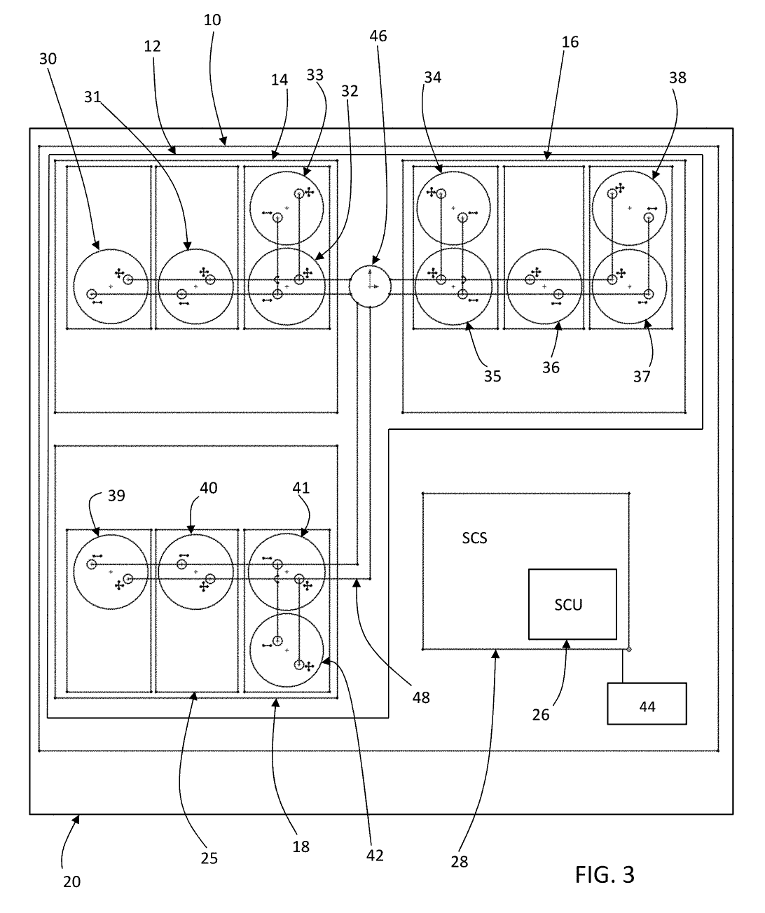

FIG. 3 illustrates a general system view of one embodiment of a supercapacitor power unit (SPU) 10 including a supercapacitor system enclosure 20 for protection from the natural elements and other damage such as may be caused by vibration and electrical shorts. In alternative embodiments, SPU 10, SCS 28, and one or more supercapacitor cells have separate enclosures. In some embodiments, these enclosures are in the form of a polymer shell. For example FIG. 3 illustrates a cell enclosure 25. In this embodiment, SPU 10 comprises a supercapacitor bank (SCB) 12, a supercapacitor charging and control system (SCS) 28, charge terminals 45 for receiving current from a charging system, and power unit electrical terminals 44 for delivering power to a load. SCB 12 comprises two or more supercapacitor bank parts (SBP) each comprising one or more supercapacitors and illustrated here as a first supercapacitor bank part 14, a second supercapacitor bank part 16, and a third supercapacitor bank part 18. Supercapacitor cells within a SBP are joined in series but also illustrated to show where one or more supercapacitor cells may be joined in parallel. As further illustrated for example in FIG. 3, first supercapacitor bank part 14 comprises a first supercapacitor cell 30, a second supercapacitor cell 31, and a third supercapacitor cell 32 all electrically coupled in series. Second supercapacitor bank part 16 comprises a sixth supercapacitor cell 35, a seventh supercapacitor cell 36, and an eighth supercapacitor cell 37 all electrically coupled in series. A third supercapacitor bank part 18 comprises a tenth supercapacitor cell 39, an eleventh supercapacitor cell 40, and a twelfth supercapacitor cell 41 all electrically coupled in series. As further illustrated, several of the illustrated supercapacitors are electrically coupled in parallel including; third supercapacitor cell 32 and fourth supercapacitor cell 33, fifth supercapacitor cell 34 and sixth supercapacitor cell 35, eighth supercapacitor cell 37 and ninth supercapacitor cell 38, twelfth supercapacitor cell 41 and thirteenth supercapacitor cell 42. Each SBP may comprise an equal or unequal number of supercapacitor cells as illustrated. Note also from FIG. 3, a SCB 12 may comprise two or in this example more than two SBPs. Supercapacitor power unit (SPU) 10 further comprises an inter-part switch 46 for electrically dividing the SCB 12 into distinct SBPs by electrically isolating each SBP when inter-part switch 46 is opened. A supercapacitor control system (SCU) 26 controls various switches and other electronic components in a supercapacitor power unit 10.

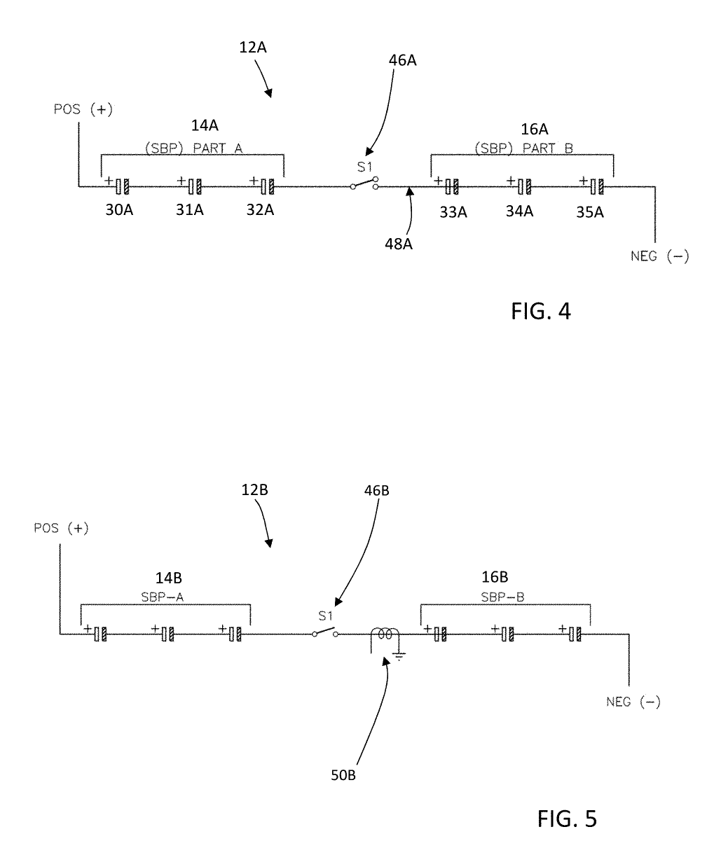

FIG. 4 illustrates in electrical schematic form one embodiment of a simplified layout of a supercapacitor bank 12A. In this embodiment, supercapacitor bank 12A is divided by an inter-part switch 46A also labeled here as S1. Supercapacitor cells 30A-32A, and 33A-35A on each side of inter-part switch 46A are electrically coupled in series to form supercapacitor bank part A (14A) and supercapacitor bank part B (16A). Electrical conductors 48A electrically couple one electronic component to another. As indicated in the illustration, each supercapacitor is joined in series terminating in a positive terminal and a negative terminal. When inter-part switch 46A is closed, a load placed across the positive and negative terminal will draw the full voltage of the SCB 12A.

A SCB may assume a variety of forms. For example, in other embodiments a SCB comprises one or more switches electrically dividing a supercapacitor bank into more than two supercapacitor bank parts (SBP) as was illustrated in FIG. 3. In preferred embodiments, the quantity of supercapacitor cells and electrical specifications of each supercapacitor cell are the same for each SBP. In other embodiments, many different combinations of supercapacitor cell quantity and electrical specifications may be used. Unequal quantities of supercapacitors or supercapacitors having unequal electrical specifications may be used in one SBP versus another SBP within the same SCB as was illustrated in FIG. 3 whereby first supercapacitor bank part 14 comprised four supercapacitors and second supercapacitor bank part 16 comprised five supercapacitors. Similarly, within a single SCB or single SBP, one supercapacitor may be rated at 3300 Farads whereas another may have an unequal electrical specification such as 1600 Farads. In preferred embodiments, each supercapacitor within a SBP is connected in series. In alternative embodiments, a SBP may include two or more of the supercapacitors electrically connected in parallel. In preferred embodiments, output voltage of a first SBP is generally matched with the output voltage of all or with the output voltage of a second, third, or fourth SBP. In alternative embodiments, the output voltage of a first SBP is mismatched with the output voltage of a second, third, or fourth SBP. For example, three supercapacitors joined in series in a first SBP may produce an output voltage of 9.0V whereas, supercapacitor output in a second SBP may produce a mismatched output voltage of 8.0V.

Circuits within a supercapacitor system may include one or more voltage or current sensors to monitor the status of the system. For example (FIG. 5), through the use of a current sensor 50B, a user may be notified about the status of a SCB 12B. Current sensor 50B sensing high current may indicate that SCB 12B is discharging into a load. Current sensor 50B sensing low current may indicate that SCB 12B needs to be recharged.

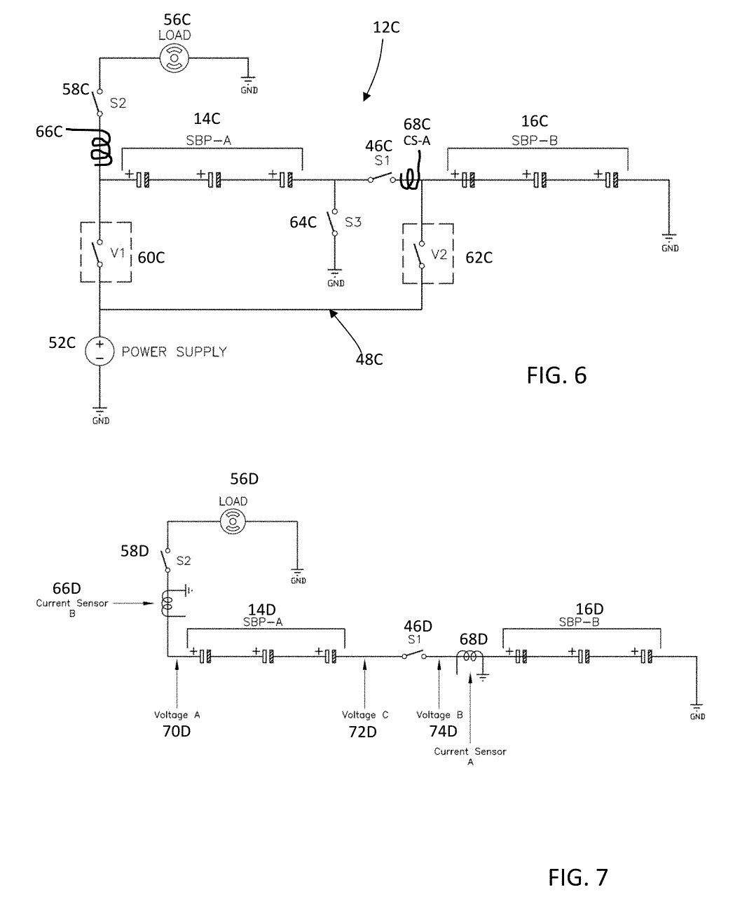

FIG. 6 illustrates a simplified example embodiment of a SCB 12C with an integrated first supercapacitor charging circuit 52C and load 56C. In this embodiment, a first and second supercapacitor bank part are designated as SBP-A (14C) and SBP-B (16C). Here the SBPs are matched each comprising three supercapacitors. S1 is an inter-part switching device (46C) whereas S2 represents a first load-switching device (58C) for supplying and interrupting current to a load (56C). V1 is a first supercapacitor bank switch (60C) and V2 is a second supercapacitor bank switch (62C). Each of these bank switching devices 60C and 62C conduct in one switch position and interrupt in another switch position thereby controlling electrical charge current from a power supply 52C to individual first and second SBP 14C, 16C. This system is therefore changeable between a load state (mode) and a charge state (mode). In a load state, SCB 12C supplies a current to a load 56C. Power supply 52C may be an isolated DC-DC power supply. A method to change to a load state involves the steps of opening first supercapacitor bank switch 60C, second supercapacitor bank switch 62C, and first grounding switch 64C (S3). Then closing inter-part switch 46C(S1) and first load switch 58C (S2). This switch arrangement causes first supercapacitor charging circuit to be isolated from SCB 14C and 16C and prevents a loss of current to ground from supercapacitor bank 12C through first grounding switch 64C (S3). Current from the SCB 12C is available to flow to load 56C through first load switch 58C (S2).

A charge state follows a load state for recharging SCB 12C. A method to change to a recharge state involves the steps of opening of inter-part switch 46C (S1) and first load switch 58C (S2) then closing first supercapacitor bank switch 60C (V1), second supercapacitor bank switch 62C (V2), and first grounding switch 64C (S3). Opening of inter-part switch 46C divides SCB 12 into discrete SBPs, first SBP 14C and second SBP 16C. Opening of first load switch 58C (S2) prevents current from being lost to load 56C while first SBP 14C and second SBP 16C is charging. Closing first capacitor bank switch 60C (V1) provides an electrical pathway for current to flow from a power supply in first supercapacitor charging circuit 52C into first SBP 14C while closing second supercapacitor bank switch 62C (V2) provides an electrical pathway for current to flow from the power supply in first supercapacitor charging circuit 52C into second SBP 16C for electrical recharge. Closing first grounding switch 64C (S3) completes the electrical circuit during recharge of first SBP 14C. In some forms, first supercapacitor bank switch 60C or second supercapacitor bank switch 62C or both 60C, 62C may be constant current and constant voltage regulated switches to prevent harmful flows of one or more of voltage and current to any one SBP.

In preferred embodiments, current sensors or voltage sensors or both current and voltage sensors may be used to monitor voltages at strategic points within the circuit to implement specific actions. For example and as further illustrated in FIG. 6, first current sensor 66C is positioned to monitor current flowing to load 56C. This sensor information from 66C is then transmitted to a user who may act on this information as they prepare to change to a charge state. For example, leaving first load switch 58C closed during recharge would cause the recharge current to be redirected to load 56C instead of first and second supercapacitor bank part 14C, 16C. In some configurations, a user may manually open a first load switch 58C if 58C is so capable for manual operation, whereas in other configurations an electronic method may be used such as a microcontroller programmed not to close first and second supercapacitor bank switches 60C and 62C for charging until first load switch 58C is opened therein preventing further discharge to load 56C. Depending on the configuration, the charging system comprising first supercapacitor charging circuit 52C may or may not control first load switch 58C. For example, in one application a supercapacitor power unit may be electrically integrated into a hydraulic lift wherein the supercapacitor power unit (SPU) is used to provide a short term power burst when the lift raises and lowers. The lift and SPU may be sold as an integrated unit with controllers within the circuitry having direct control over a first load switch such as 58C. In a different example, the SPU may be configured to provide a burst of power to a separated power consuming entity such as the starter of a large truck engine. In this form, a first load switch is in the form of the truck's ignition switch which is controlled entirely by the action of the user turning the ignition key.

Similarly, second current sensor 68C (CS-A) (FIG. 6) indicates the state of inter-part switch 46C by monitoring the current at the sensor point in the circuit. Instantaneous current flow through second current sensor 68C indicates inter-part switch 46C is closed and therefore first supercapacitor bank part 14C and second supercapacitor bank part 16C are connected in series. When attempting to change to a charge state from a load state, sensor information from second current sensor 68C informs the system (perhaps a microcontroller) that inter-part switch 46C is currently closed and must be opened before a recharge state can be initiated.

Voltage sensors may also be used in the system. In some forms voltage sensors are used to measure the voltage of individual SBPs. These measured voltages can then be used as the basis to change circuit parameters. An example is illustrated in FIG. 7 where a supercapacitor bank is illustrated with components replicating the circuit in FIG. 6 but absent charging circuits and first grounding switch. In this embodiment components designated with a ‘D’ designation. With inter-part switch 46D open, SCB 12D is divided into first supercapacitor bank part 14D and second supercapacitor bank part 16D. In addition, with first load switch 58D open, first supercapacitor bank part 14D is prevented from draining its charge into load 56D. Measured voltage from Voltage A point (70D) of first capacitor bank 14D, and measured voltage from Voltage B point (74D) of second capacitor bank 16D is then conveyed to a microcontroller. Presets within the microcontroller initiate actions based on the voltage readouts. For example in FIG. 7, Voltage A 70D represents the charge voltage of first supercapacitor bank part 14D and Voltage B represents the charge voltage of second supercapacitor bank part 16D. If either of these voltages are less than a predetermined fully charged voltage for the respective supercapacitor bank, then the microcontroller may continue to keep first supercapacitor bank switch and second supercapacitor bank switch closed until each SBP is fully charged. Alternatively, if one SBP is fully charged but the other bank is only partially charged, the microcontroller may then open first supercapacitor bank switch or second supercapacitor bank switch to turn off charge to the fully charged SBP. In addition, the microcontroller may then redirect the charge amperage directed to the no longer needed charge circuit and use it to boost the charge rate on the partially charged SBP. Alternatively, in the event both SBPs are not fully charged and the measured voltage of one SBP is lagging behind the other, the microcontroller may be configured to direct more of the charge current towards the lagging SBP such that both SBPs may become fully charged at the same time. Of course if both SBPs are fully charged, the microcontroller may then open both a first supercapacitor bank switch and second supercapacitor bank switch to disassociate the charging circuit. It will be recognized by one skilled in the art that the operation of the circuit can be controlled to provide an infinite number of responses based on the voltage and current measured at various points within the supercapacitor bank and charging circuits.

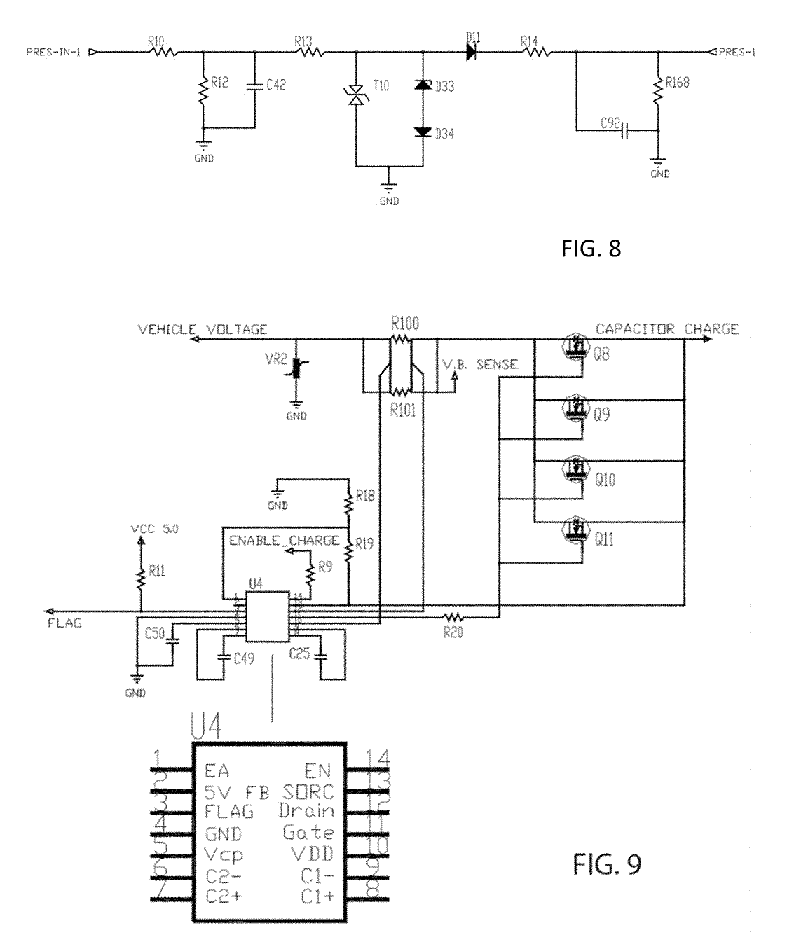

The voltage and current sensing circuits may assume a variety of forms many of which are available on the market or otherwise in the prior art. FIG. 8 illustrates just one example of a typical voltage sensing circuit. This circuit for example could be used to sense voltage at Voltage A 70D, Voltage B 74D, or Voltage C 72D of FIG. 7. The left end of this circuit labeled PRES-IN-1 is electrically joined to the circuit at the Voltage A, Voltage B, or Voltage C points in FIG. 7. The right end of the circuit (PRES-1) is output from the voltage sensor and is electrically joined to an appropriate input of a microcontroller for control of switches such as at 58D, 46D or other components such as the first and second supercapacitor bank switches discussed previously.

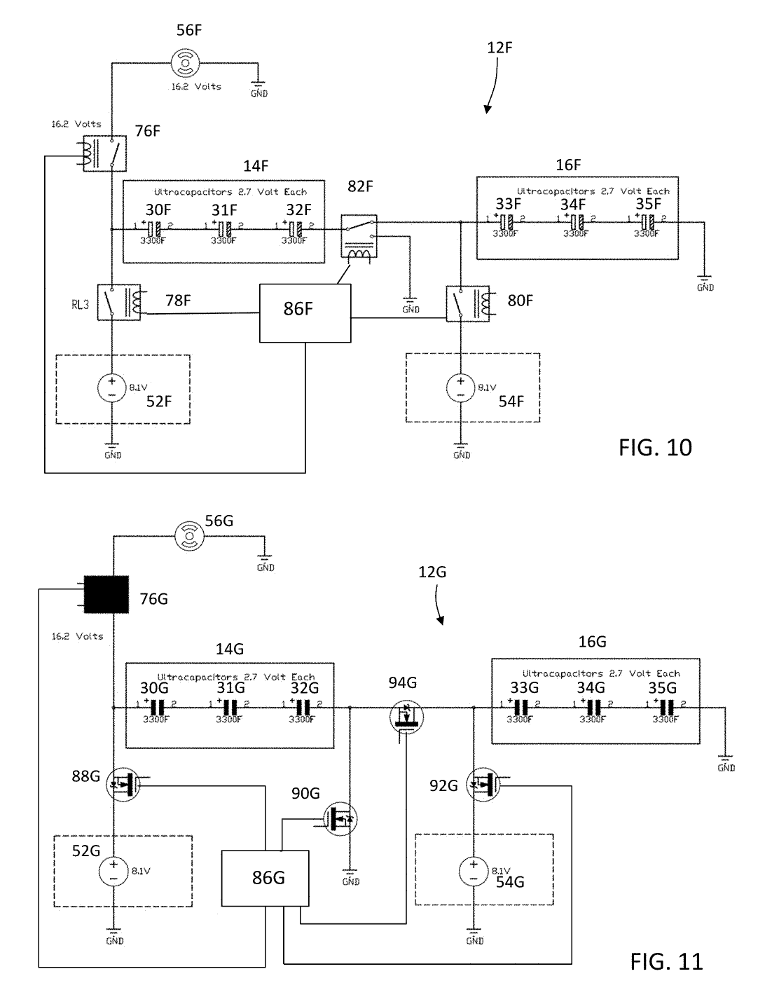

FIG. 10 illustrates yet another embodiment of a dividable SCB 12F with associated charging circuits and load 56F. SCB 12F has a voltage output of 16.2V in a load state but is divided into two identical 8.1V SBPs in a charge state. In this embodiment, a first SBP 14F comprises three 2.7V-3300 Farad supercapacitors connected electrically in series and an identical second SBP 16F. As illustrated, a load 56F operates at 16.2 volts. First through fourth general purpose relays (76F-82F respectively) are used as switches to open and close various parts of a circuit. Relays 76F-82F in this embodiment are controlled by 5V output from a microcontroller 86F. Although not illustrated, one or more of voltage (70D, 72D, 74D) and current (66C, 68C) sensing circuits discussed previously in FIGS. 6 and 7 may be used for input for switch control. The steps to begin operation in a recharge state include sensors providing a microcontroller 86F input data regarding the electrical status of the supercapacitor banks and associated circuitry as discussed previously. Microcontroller 86F then sends power to open first relay 76F to disconnect load 56F, switching fourth relay 82F to close the ground pole and divide supercapacitor banks 14F and 16F, and closing third relay 80F and second relay 78F. In other words, disconnecting the load, electrically dividing the SBPs, grounding ungrounded SBPs, and closing the charging circuits associated with first SBP and second SBP.

Steps to transform from a charge state to a load state to power a load 56F include microcontroller 86F opening second relay 78F and third relay 80F, switching fourth relay 82F to the supercapacitor pole, and closing first relay 76F. In other words, disconnecting the charging circuits from a first SBP 14F and a second SBP 16F, removing charge mode grounds from the ungrounded SBPs, rejoining the SBPs in series, and closing the load circuit.

FIG. 11 illustrates yet another embodiment of a dividable SCB 12G with associated first supercapacitor charging circuit 52G and second supercapacitor charging circuit 54G and load 56G. This circuit is a variant of the circuit illustrated in FIG. 10 as it uses a combination of electrical relays and metal-oxide-semiconductor field-effect transistors (MOSFETS) all controlled by a microcontroller 86G. In this embodiment a first relay 76G controls discharge of SCB 12G to load 56G. Except for first relay 76F in FIG. 10, the remaining FIG. 10 relays are substituted with micro-controlled first through fourth MOSFETS 88G-94G in the embodiment of FIG. 11. Fourth MOSFET 94G and second MOSFET 90G of FIG. 11 substitute for fourth relay 82F used in the FIG. 10 embodiment. Fourth MOSFET 94G operates to divide SCB 12G into SBP portions (first SBP 14F, second SBP 16F) when opened at which time second MOSFET 90G operates to close the circuit to ground thereby completing first supercapacitor charging circuit 52G during electrical recharge. Fourth relay 82F in FIG. 10 performed the same function by switching to electrically join the SBPs in a load mode and to divide the SBPs and closing the recharge circuit to ground in a charge mode.

Charging circuits may assume a variety of forms many of which are available on the market or otherwise in the prior art. FIG. 9 illustrates just one example of a basic charging circuit for recharge of a supercapacitor bank. For example, this charging circuit may be used at as first supercapacitor charging circuit 52F, 52G and second supercapacitor charging circuit 54F, 54G of FIG. 10 and FIG. 11. This particular circuit in FIG. 9 includes a voltage regulator controller and one or more current sensor.

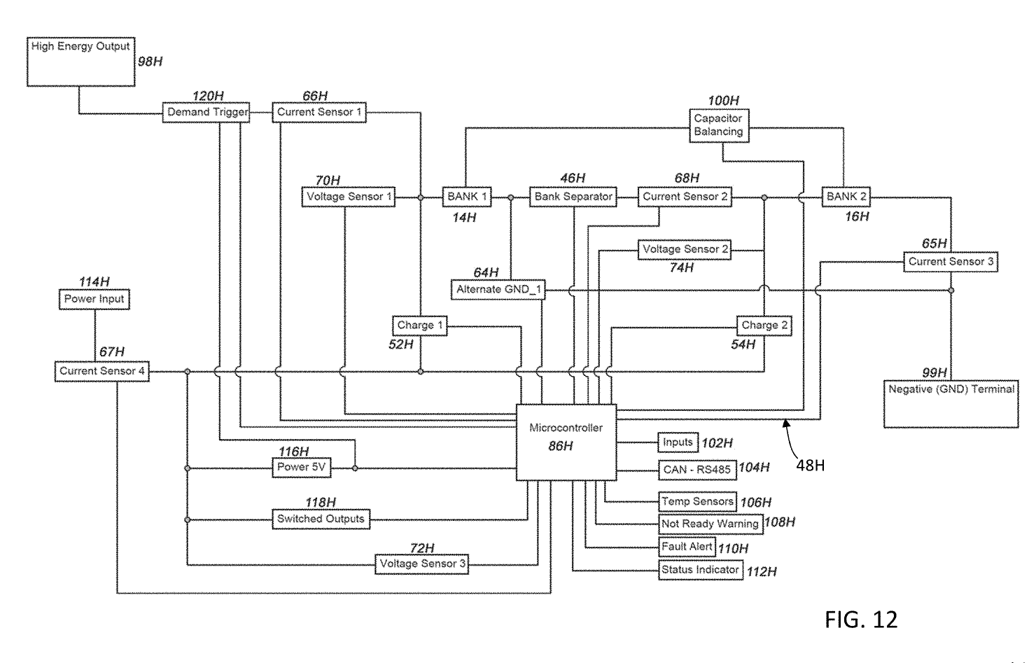

FIG. 12 schematically illustrates a preferred embodiment of a supercapacitor power unit. In the top left of the schematic, a high energy output terminal 98H represents a high current output terminal of a SPU containing a supercapacitor bank and associated supercapacitor charging and control system (SCS) circuitry. High energy output terminal 98H is electrically coupled to a demand trigger 120H which in preferred embodiments is an electrical circuit using a pull-up resistor that is pulled down upon a demand from an external load. A demand trigger 120H may include a diode that prevents pull up voltage from changing when a load is being powered. Schematically illustrated near the top of FIG. 12 is a capacitor balancing circuit 100H electrically coupled between a first supercapacitor bank part 14H and a second supercapacitor bank part 16H. A capacitor balancing circuit 100H adjusts the electrical balance between a first supercapacitor bank part 14H and a second supercapacitor bank part 16H in response to a supercapacitor bank 12H moving between a charge state wherein a first SBP 14H and a second SBP 16H are electrically divided, and a combined configuration whereby each SBP 14H, 16H is electrically coupled. A balancing circuit 100H may be in a passive balancing form or an active balancing form. In some forms an active or passive balancing circuit controls its ground in response to a supercapacitor bank (SCB) alternating between separated and combined configurations due to switching of bank separator 46H. First current sensor 66H monitors current to a load electrically coupled to the high energy output 98H and super capacitor ground terminal 99H. Fourth current sensor 67H monitors current flowing from a power input 114H (such as a vehicle's charging system) serving to power first supercapacitor charging circuit 52H and second supercapacitor charging circuit 54H. A third voltage sensor 72H monitors voltage supplied to one or more supercapacitor charging circuits 52H, 54H. In some embodiments, charging circuits 52H, 54H comprise an isolated DC-DC power supply with an output voltage no greater than its input voltage. A first voltage sensor 70H monitors the level of charge of first supercapacitor bank part 14H whereas a second voltage sensor 74H monitors the level of charge of second supercapacitor bank part 16H when bank separator 46H is open thereby electrically dividing SCB 12H. Third current sensor 65H monitors the current at supercapacitor ground terminal 99H. First grounding switch 64H provides a ground path during a charge stage for a supercapacitor bank part losing a ground due to opening of bank separator 46H. As illustrated in FIG. 12, many of these components provide one or more of circuit status inputs to microcontroller 86H and receive controlling signals from a microcontroller. Microcontroller 86H may output 5V power 116H for control of one or more relays. One or more switched outputs 118H may extend from microcontroller 86H. Some embodiments may comprise additional microcontroller circuits including: inputs 102H, CAN-RS485 104H, inputs signals from temperature sensors 106H, not ready warning circuits 108H, fault alert 110H to show a circuit problem, and output to a status indicator to show the system is ready for example.

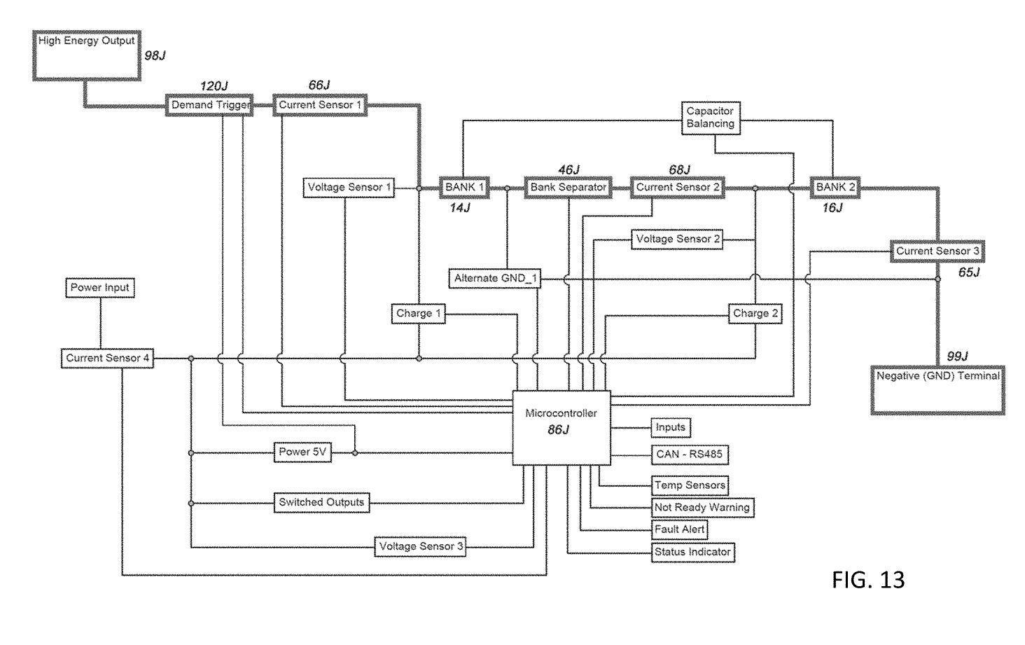

FIG. 13 replicates the FIG. 12 illustration highlighting in bold a high current path for powering a load when a supercapacitor bank 12J is in a load mode wherein bank separator 46J electrically couples one or more SBPs here illustrated as first and second supercapacitor bank parts 14J, 16J. A super capacitor ground terminal 99J represents a system ground. This system ground may connect for example to a vehicle ground or battery negative. At an opposing end of the high current path is a high energy output terminal 98J for electrically coupling to a positive of a load. A first current sensor 66J monitors the current supplied to a load. A second current sensor confirms that bank separator 46J is closed and the supercapacitor bank 12J is discharging.

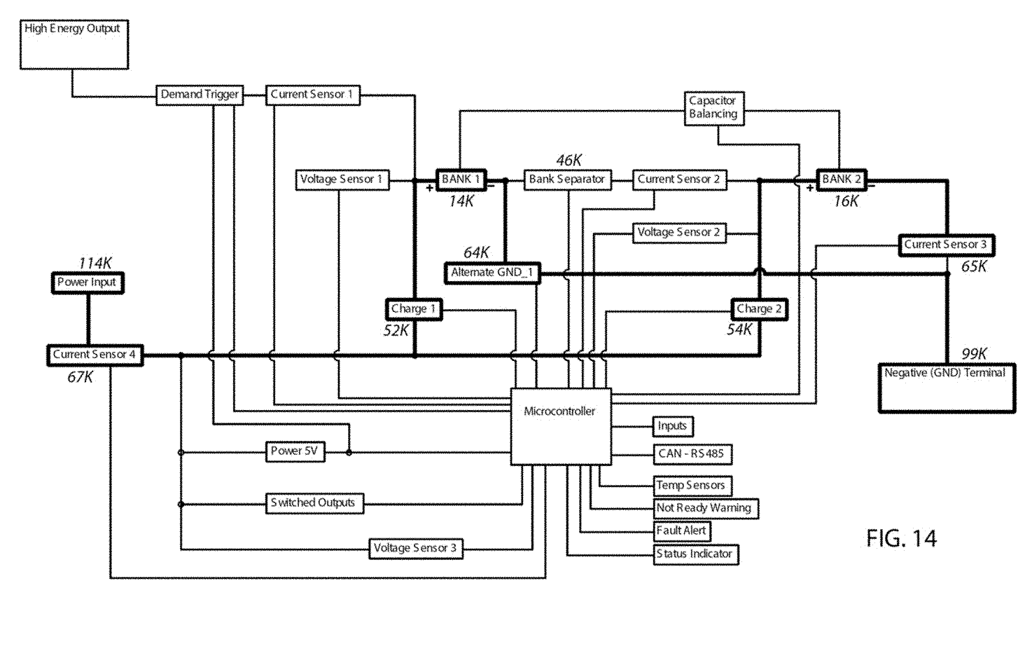

FIG. 14 highlights in bold line a charging path of a first supercapacitor charging circuit 52K and a second supercapacitor charging circuit 54K to one or more supercapacitor banks parts such as first and second supercapacitor bank parts 14K, 16K. The electrical path travels between a power input 114K which may be a charging system of a vehicle to a negative ground terminal 99K. Here a bank separator 114K remains open thereby separating a SCB 112K into one or more SBPs (14K, 16K). A first and second supercapacitor charging circuit represented 52,K, 54K charge each SBP 14K, 16K. A plurality of current sensors are illustrated to monitor the electrical status of the circuit and providing signal feedback to a microcontroller 86K as was described earlier in relation to FIG. 12.

In some embodiments circuitry of a bank separator 46H may use one or more temperature sensor inputs to control the separation or combining of supercapacitor bank parts in a supercapacitor bank 12H or to protect one or more SBPs. There are various temperature sensor circuits that are known in the prior art.

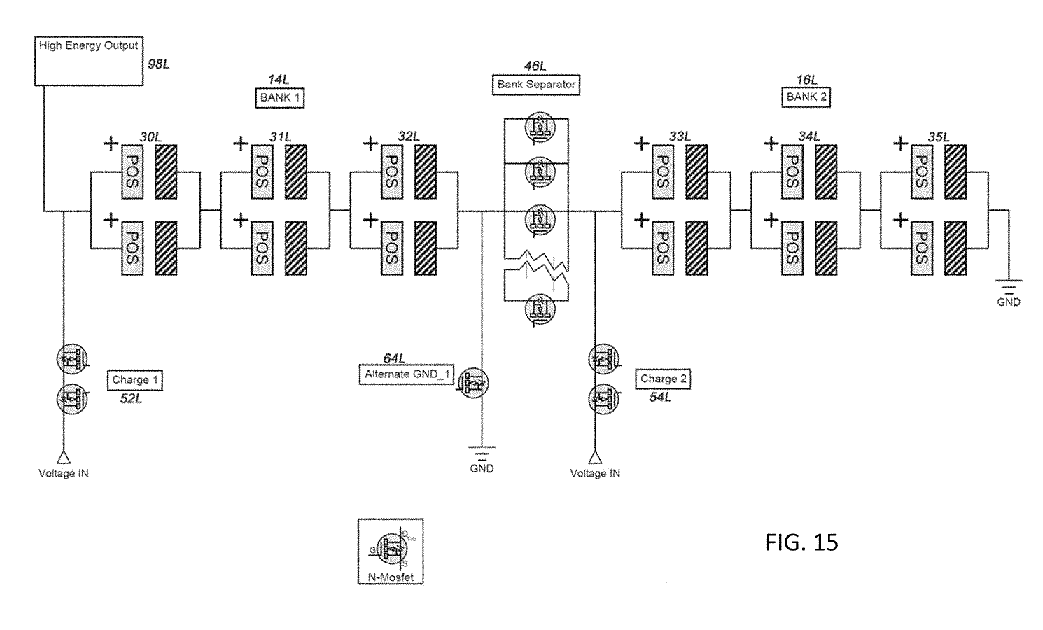

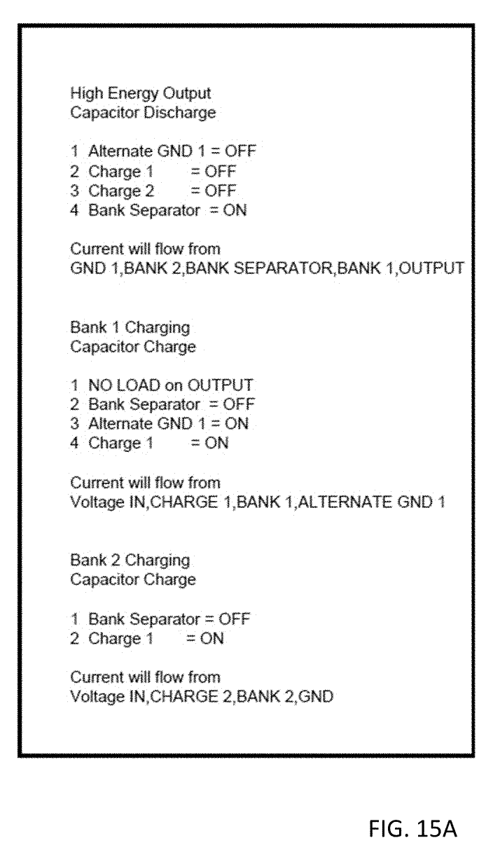

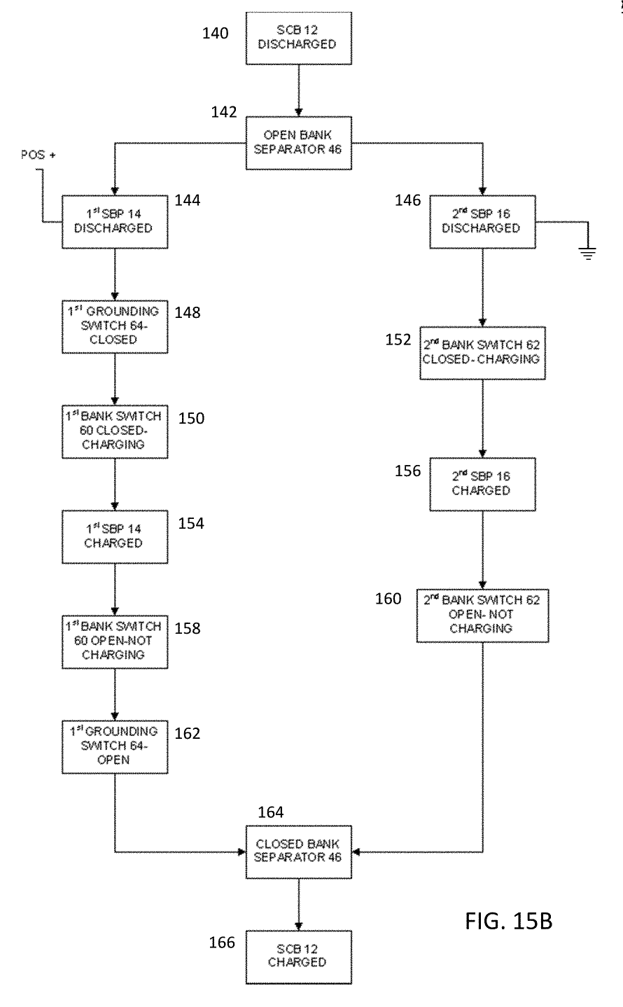

FIG. 15 illustrates an electrical schematic view of a bank separator 46L dividing a supercapacitor bank (SCB) into a first supercapacitor bank parts 14L and a second supercapacitor bank part 16L. In this embodiment, first SBP 14L comprises a first, second, and third supercapacitor cell (30L-32L), whereas second SBP 16L comprises fourth, fifth, and sixth supercapacitor cell (33L-35L) electrically coupled in series. The circuit illustrated also comprises an alternate ground 64L. First charging circuit 52L and second charging circuit 54L are provided for charging each supercapacitor bank 14L, 16L. First grounding switch 64L (alternate ground) is provided to offer a ground to the first supercapacitor grounding circuit 52L in a charge mode when the banks are separated by bank separator 46L. Represented in 15A are flow paths and ‘on’ and ‘off’ positioning for each module for; a supercapacitor bank in a load mode, and during a charge mode when one or more of a first supercapacitor bank part 14L and a second supercapacitor bank part 16L charges.

FIG. 15B illustrates a preferred embodiment of a broad stepwise method for separating a supercapacitor bank into supercapacitor bank parts and fully recharging. In this embodiment, a supercapacitor bank 12 is discharged at step 140 typically by dispersing the stored electrical energy to a load such as a lift gate or plow on a truck. A bank separator 46 is opened at 142 causing a supercapacitor bank 12 to be electrically divided into a discharged first SBP 14 and a second SBP 16 at step 144, 146. Second SBP 16 remains coupled to ground and first SBP 14 remains coupled to positive. First grounding switch 64 is closed to provide an alternate ground to first SBP for charging. First bank switch 60 and second bank switch 62 are closed providing current flow from the charging systems at step 150 and 152. Charging continues to each supercapacitor bank part at a charge voltage that is less than the output of the SCB until both first SBP 14 and second SBP 16 are fully charged at step 154 and 156. Charging to first SBP 14 is stopped at step 158 when first bank switch 60 is opened. Charging to second SBP 16 is stopped at step 160 when second bank switch 62 is opened. Bank separator 46 is then closed at step 164 thereby electrically joining the first and second supercapacitor bank parts 14, 16 resulting in a fully charged SCB at step 166.

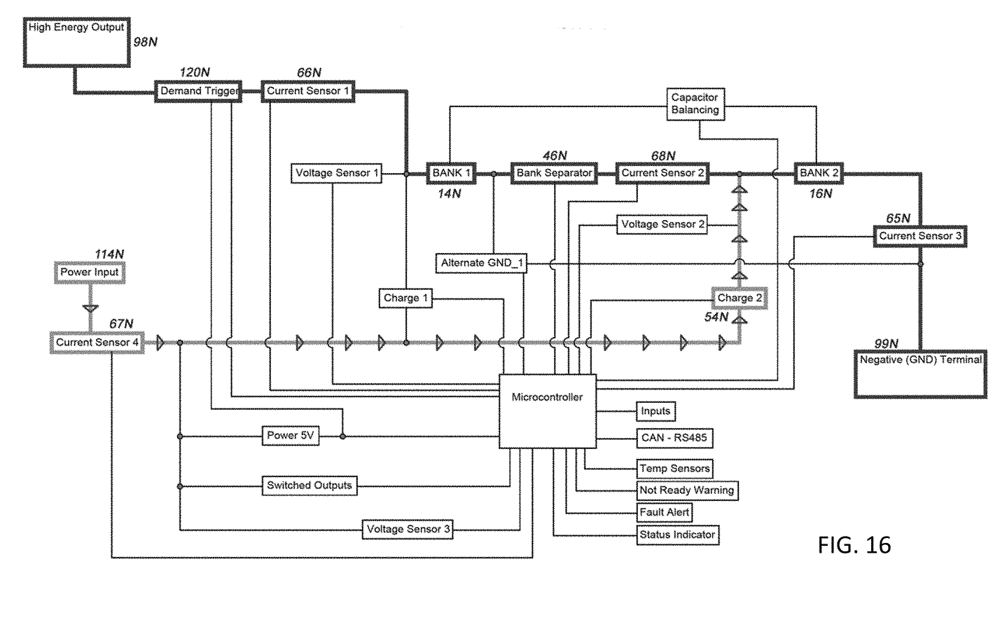

As illustrated previously in FIG. 13, FIG. 16 schematically highlights a high current path for discharge of a supercapacitor bank to a load. However, in this embodiment, the high current path is boosted along one or more of the charging paths (illustrated in gray with arrowheads) by a power input 114N typically used to recharge the supercapacitor bank. Current from power input 114N may be used to perform one or more of boosting current and decreasing the rate of current discharge from an associated SCB. In one embodiment, power input 114N is coupled to an alternator charging system of a truck. In the example of FIG. 16, current is boosted along second supercapacitor charging circuit 54N which typically serves to charge second supercapacitor bank part 16N. In some embodiments, current from a power input 114N can be applied disproportionately between banks. For example, the current from the power input 114N may be disproportionately applied to first SBP 14N to optimize charging to the SBP having a greater discharge state.

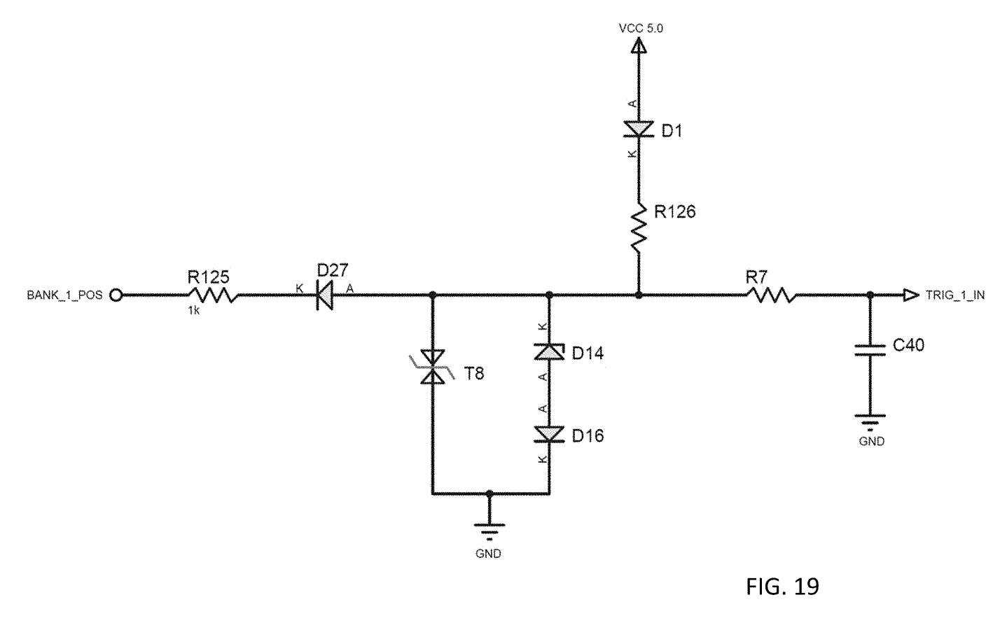

Again a demand trigger 120H is schematically illustrated in FIG. 12. An example of one form of a demand trigger circuit in electrical schematic form from the prior art is illustrated in FIG. 19. A demand trigger circuit uses a pull-up resistor that is pulled down by demand from an external load. A demand trigger circuit may also comprise a diode to prevent the pull up voltage from changing when a load is being powered. A ‘TRIG_1_IN’ side of the illustrated circuit is electrically coupled to a microcontroller whereas a ‘BANK_1_POS’ side is electrically coupled to a high energy output terminal 98H of a supercapacitor bank and to a load. In preferred embodiments one or more of a sensor (i.e. first current sensor 66H) or trigger (demand trigger 120H) is included on a high current output to detect the presence of an external load or demand without the need to identify the type of load being powered and without activating the load. Accordingly, a sensor such as first current sensor 66H can detect if the load has been switched on or off. A demand trigger may comprise for example, a pull-up resistor illustrated as R126 in FIG. 19. The pull-up resistor will be pulled down upon a demand from the external load. An input pin on an associated microcontroller will read a high state, close to 5.0V in this embodiment when a load is not being drawn. With a load drawn, an input pin on the associated microcontroller reads a low state, the current flows through the resistor to the ground thereby preventing a short. A diode is used in conjunction with the pull-up resistor in some embodiments and as illustrated in FIG. 19 as D1. Diode D1 prevents the pull up voltage from changing when the load is powered.

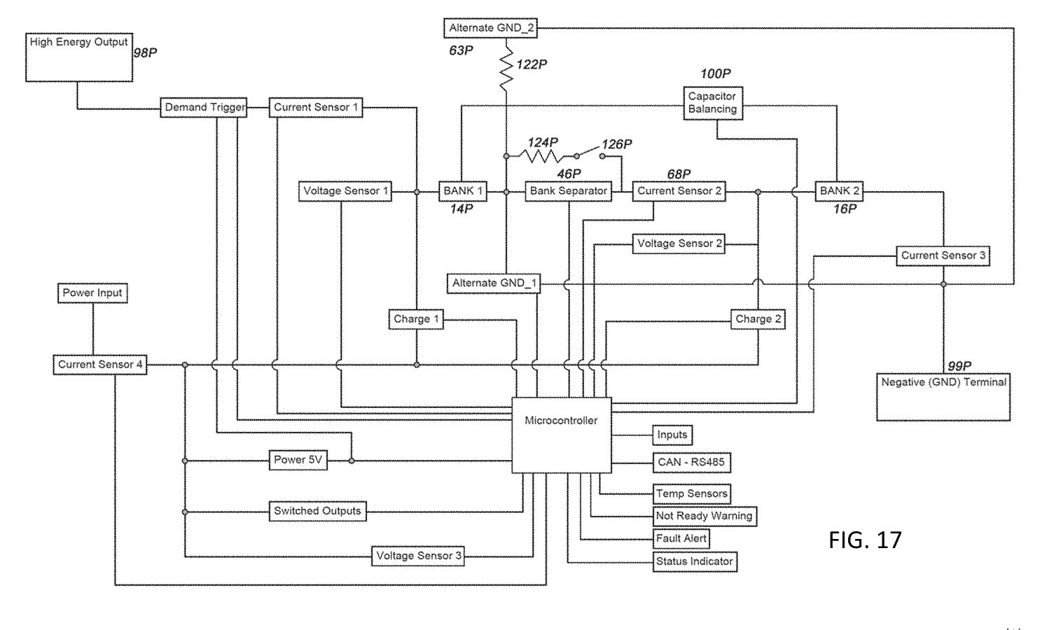

FIG. 17 schematically replicates FIG. 12 however also represent an alternative embodiment of a supercapacitor power unit (SPU) using an alternate ground path for sensing. Alternate ground 63P in the schematic represents an alternate ground path that is used for sensing. The alternate ground 63P path provides a high ohm ground path for sensing the load without activating the load.

Some embodiments comprise an alternate high ohm path across a bank separator. An example is schematically illustrated in FIG. 17 as a second high ohm path 124P circuit shown immediately above bank separator 46P in FIG. 17. In this embodiment a high ohm resistor is coupled with a resistor switch 126P. This switched resistor combination may be used for testing and sensing the voltage of the supercapacitor bank wherein the high ohm resistor circuit can be switched on and off. The circuit comprises one or more sensors that determines the status of the external load without the need of identifying the type of load being powered and without activating the load. As described earlier, in preferred forms a supercapacitor bank (SCB) can be divided into smaller supercapacitor bank parts (SBP) for charging and further comprises at least one sensor for detecting the presence of a demand or load regardless of the type of load.

A variety of microcontrollers 86H may be utilized in the system. A microcontroller may be used to receive various inputs from sensors and control output to various electronic modules in the system. A variety of sub-circuits may be used in conjunction with a microcontroller. In one form a microcontroller uses a digital potentiometer circuitry to change one or more of voltage and current of the charging circuits output that charge a supercapacitor bank having a bank separator that can separate the main bank into smaller banks for charging. In other forms a microcontroller uses a resistor ladder or network to change one or more of voltage and current output of a charging circuits. In one form, a microcontroller receives at least one input from a sensor monitoring a supercapacitor bank having a bank separator which separates a main bank into smaller bank parts. In addition, acting on input from at least one bank sensor, a microcontroller may be used to recombine various bank parts in preparation of discharge of a SCB and also adjust the current injecting parameters for the bank to optimize the recharge and discharge rates of the banks. Unassigned microcontroller banks may be used for example for CAN (controller area network), temperature sensors, charge circuits, voltage sensors, and to serve as other inputs and outputs.

In one embodiment, a circuit is monitored at a junction of the charging circuit and bank part for alerting a microcontroller to add additional current to a bank during charge or discharge.

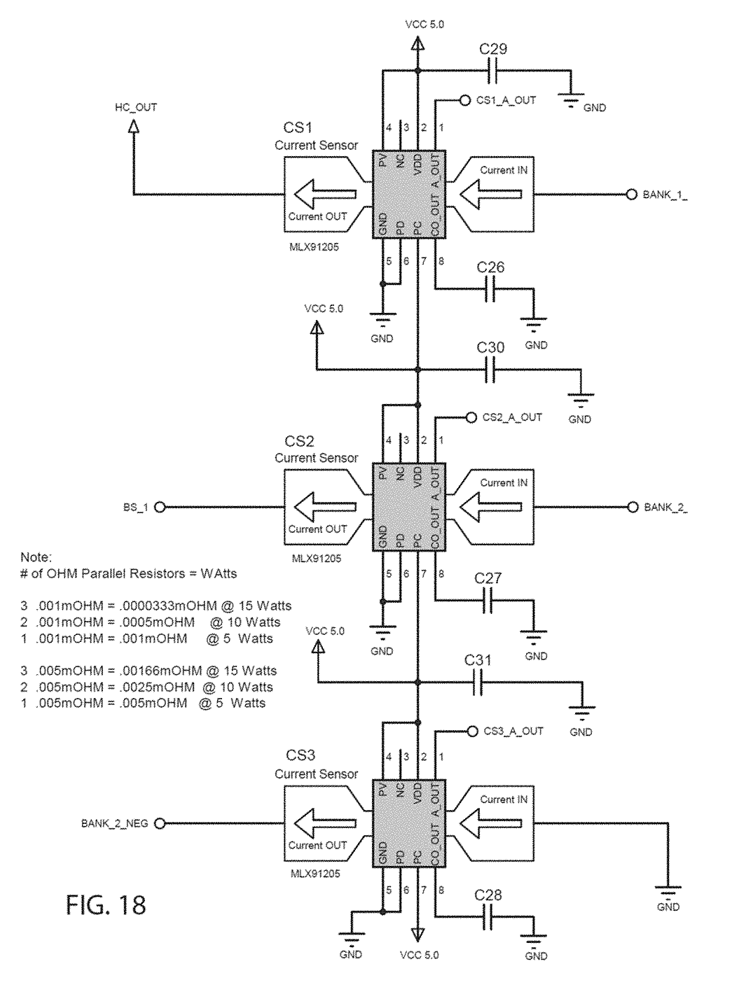

FIG. 18 is an electrical schematic illustrating one embodiment of current sensors of the prior art that may be used in a supercapacitor power unit such as illustrated in FIG. 12.

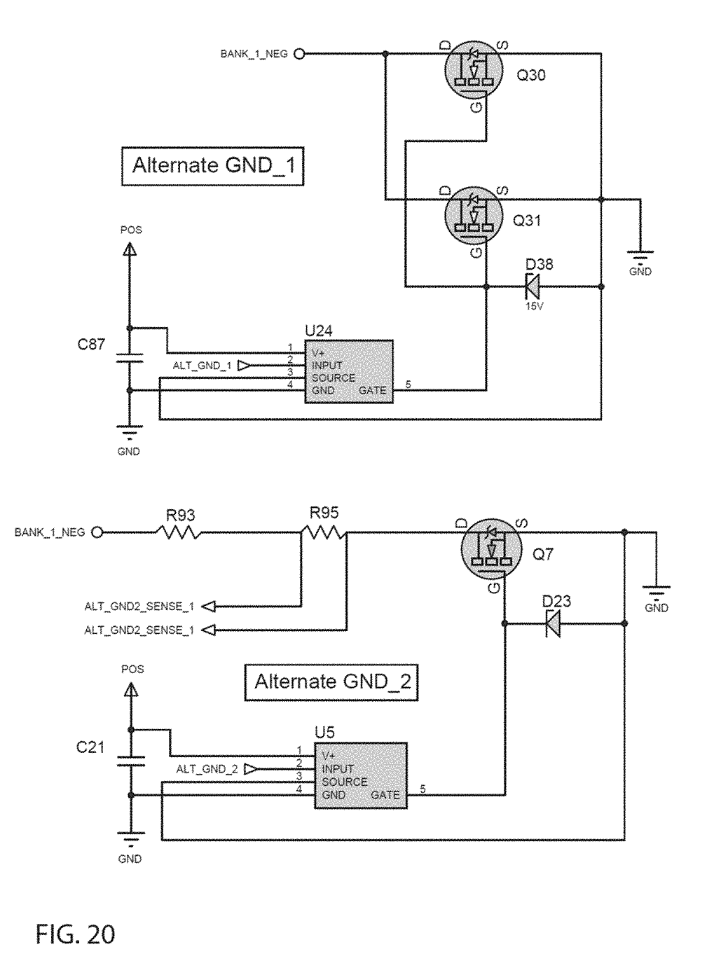

FIG. 20 is an electrical circuit schematic illustrating on the right one embodiment using a single FET of an alternate ground path for sensing purposes. Another alternate ground path having greater capacity is illustrated in the embodiment on the left of FIG. 20 wherein the circuit comprises two or more FETs. Again, alternate ground paths are used for sensing and provides a ground path for a current sensor to provide a high ohm path wherein the load can be sensed without activating the load.

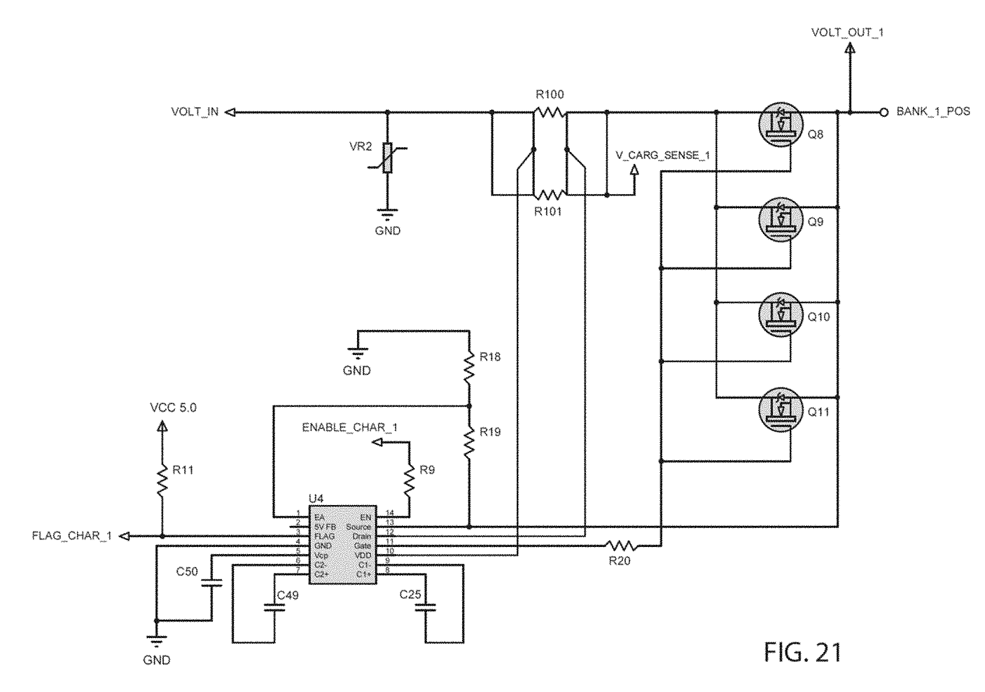

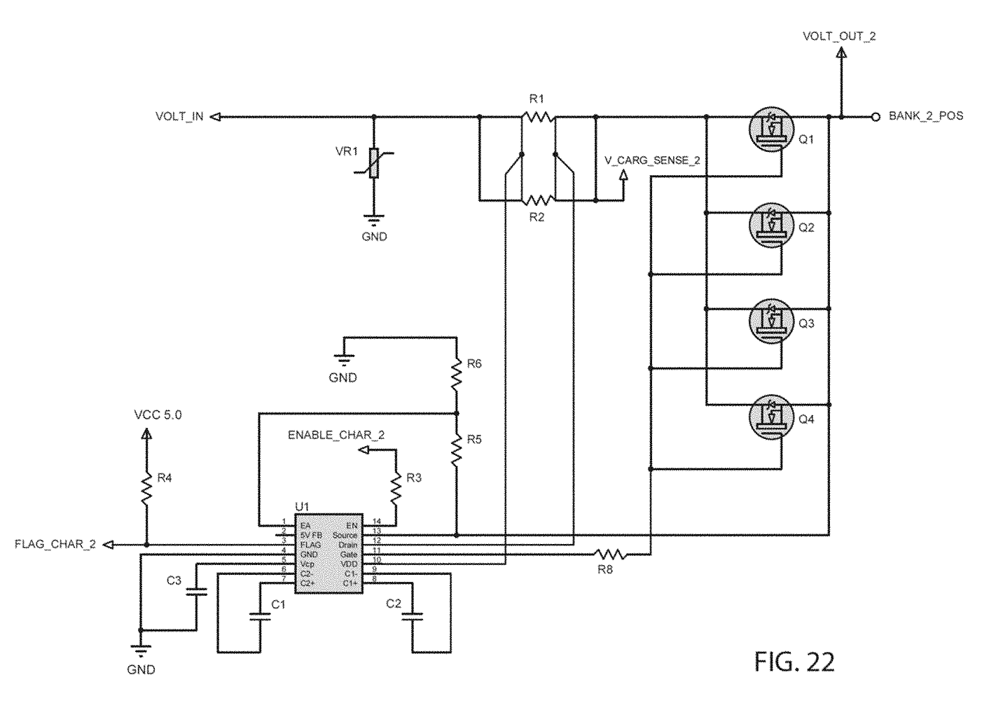

FIGS. 21 and 22 illustrate embodiments of charging circuits that may be used to charge each supercapacitor bank.

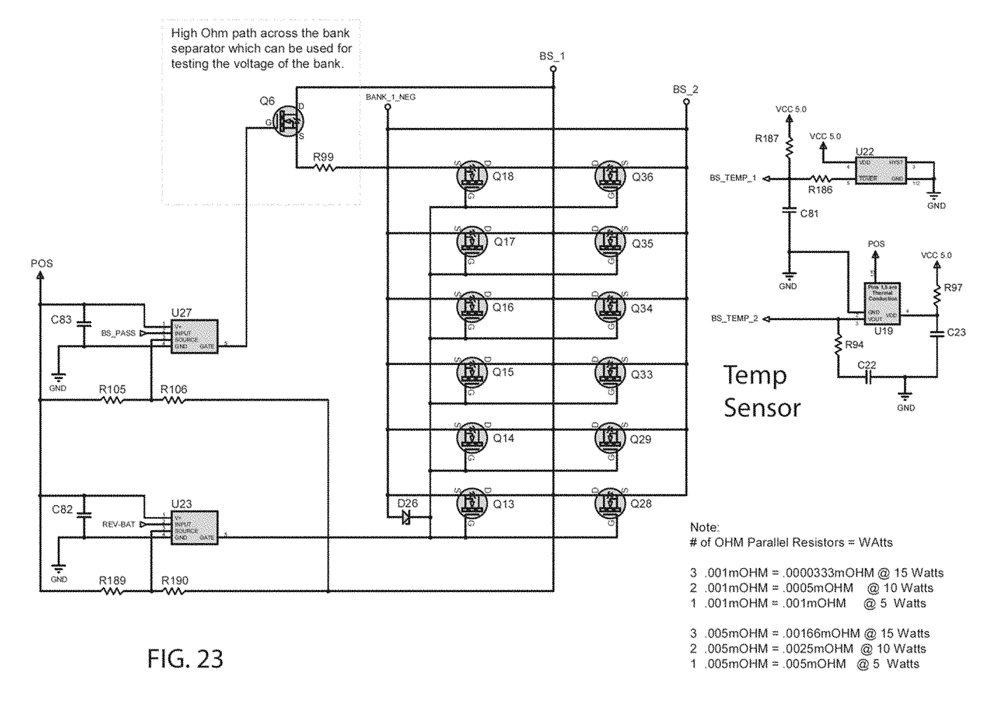

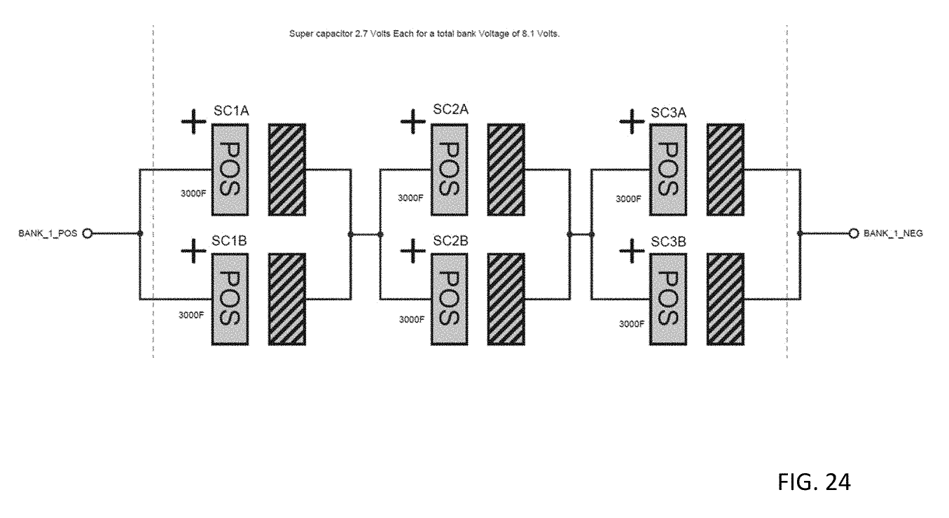

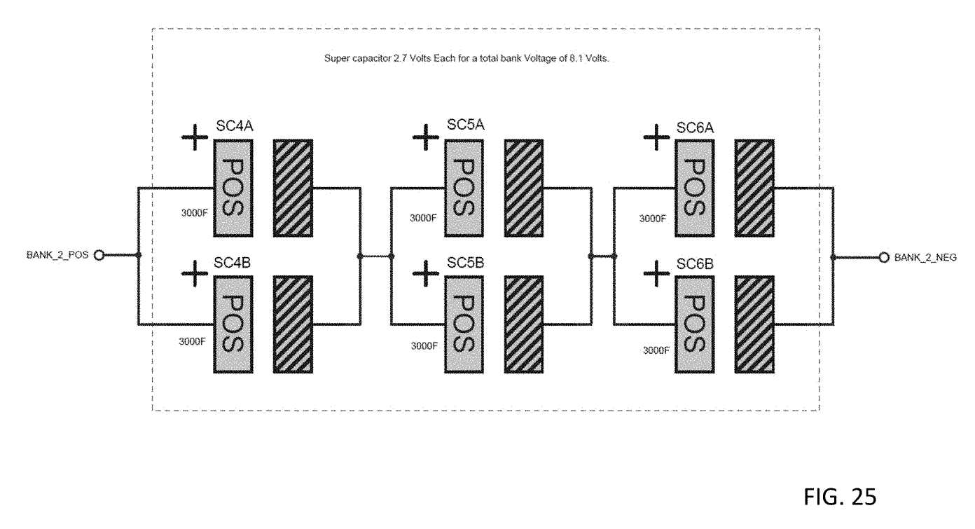

FIG. 23 is an electrical schematic of one embodiment of a bank separator circuit that may be used in accordance with a supercapacitor power unit. FIG. 23 illustrates MOSFETs in a back to back configuration providing full control of current in both directions whereas in an alternative embodiment single MOSFETs are used in a non-back to back configuration. FIG. 24 is an illustration of one embodiment of a supercapacitor bank part comprising three pairs of supercapacitors whereby each supercapacitor in a pair is electrically connected in parallel and said 3 pairs are connected in series. FIG. 25 illustrates a second supercapacitor bank part. In this embodiment, the bank parts illustrated in FIGS. 24 and 25 may be used as a first supercapacitor bank part 14H and second supercapacitor bank part 16H illustrated in FIG. 12.

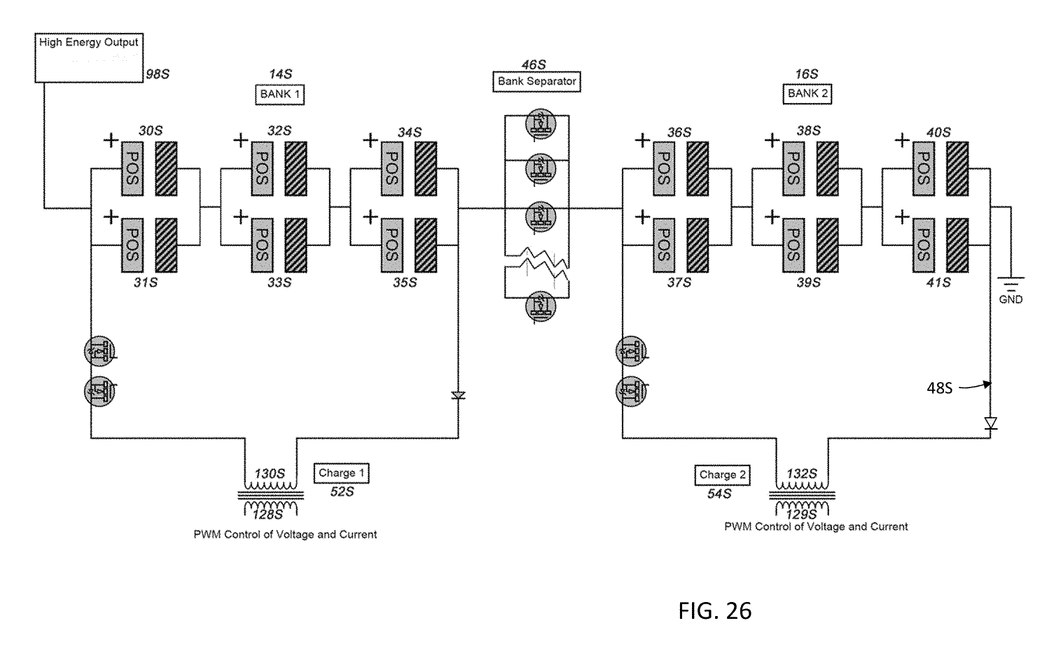

FIG. 26 illustrates an alternative embodiment of a supercapacitor bank including a bank separator 46S for dividing a supercapacitor bank into two or more supercapacitor bank parts illustrated here as first supercapacitor bank part 14S and second supercapacitor bank part 16S. In this embodiment, each SBP 14S, 16S includes its own charging system with its own ground path. The ground paths for each bank part have no conflict with each other and therefore eliminate the need and expense of alternative ground path switching. A standard transformer or simple choke having a 1:1 input to output voltage ratio may be used. This primary coil 128S to first secondary coil 130S ratio is used with PWM (pulse width modulation) for control of voltage and current providing direct transfer of power to the first secondary coil 130S. In some forms the power supplied to primary coil 128S is supplied from a charging system of a truck or similar utility vehicle. Second primary coil 129S cooperates with second secondary coil 132 to charge second SBP 16S. The first and second supercapacitor banks 14S, 16S are illustrated using first through twelfth supercapacitor cells 30S-41S.

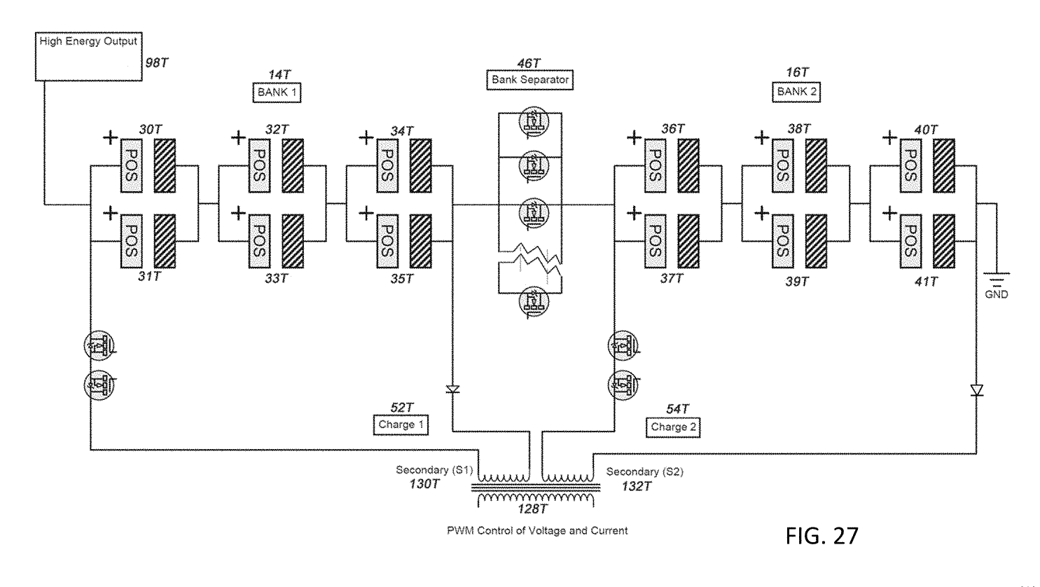

FIG. 27 illustrates another alternative embodiment of a supercapacitor bank including a bank separator 46T for dividing a supercapacitor bank into two or more supercapacitor bank parts illustrated here as first supercapacitor bank part 14T and second supercapacitor bank part 16T. In this embodiment, each SBP 14S, 16S includes its own charging system (first supercapacitor charging circuit 52T, second supercapacitor charging circuit 54T) each with its own ground path. Ground paths for each SBP 14T, 16T have no conflict with each other and therefore again eliminate the need and expense of alternative ground path switching. In this embodiment, a standard transformer or simple choke having one primary coil 128T winding and two or more secondary coil windings (first secondary coil 130T, second secondary coil 132T) are used with PWM (pulse width modulation) for control of voltage and current to provide direct transfer of power distributed between secondary coils 130T, 132T. In this embodiment there are two secondary coils. If for example, a primary coil 128T operated at 20 amps, each first and second secondary coils 130T, 132T would operate at 10 amps each for charging first supercapacitor bank part 14T and second supercapacitor bank part 16T. In the examples illustrated in FIGS. 26 and 27, the inductor is used to transfer voltage and not used to boost voltage.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A supercapacitor bank and charging system comprising:
at least two supercapacitor cells;
an electrical conductor;
said electrical conductor coupling in series said at least two supercapacitors to form a supercapacitor bank;
a supercapacitor bank separator circuit;
said supercapacitor bank separator circuit interrupting said conductor in a charge mode to form at least two supercapacitor bank parts;
said at least two supercapacitor bank parts forming a supercapacitor bank in a load mode when said bank separator circuit is closed;
a supercapacitor charge system;
said supercapacitor charge system electrically coupled separately to each said at least two supercapacitor bank parts for recharging each said supercapacitor bank part;
and wherein said supercapacitor bank is electrically coupled to a load.

2. The supercapacitor bank and charging system of claim 1 wherein said supercapacitor bank parts are charged using an isolated DC-DC conversion power supply.

3. The supercapacitor bank and charging system of claim 2 wherein said isolated DC-DC power supply comprises a transformer.

4. The supercapacitor bank and charging system of claim 3 wherein said transformer of said isolated DC-DC power supply has an output voltage no greater than its minimum input voltage.

5. The supercapacitor bank and charging system of claim 3 wherein said isolated DC-DC power supply transformer has a 1:1 input to output voltage.

6. The supercapacitor bank and charging system of claim 3 wherein said transformer comprises secondary windings that can be electrically uncoupled from said load.

7. The supercapacitor bank and charging system of claim 2 wherein said isolated DC-DC conversion power supply has one or more of a diode and MOSFET to prevent reverse voltage and current flow.

8. The supercapacitor bank and charging system of claim 2 wherein said transformer further comprises multiple secondary windings.

9. The supercapacitor bank and charging system of claim 8 wherein each secondary winding of said isolated transformer is electrically coupled to a supercapacitor bank part for charging each said supercapacitor bank part.

10. The supercapacitor bank and charging system of claim 1 wherein a said supercapacitor bank part has one or more of a sensor and a trigger on its high current output for detection of one or more of a demand and load.

11. The supercapacitor bank and charging system of claim 10 further comprising a pull-up resistor that is pulled down upon a demand from an external load.

12. The supercapacitor bank and charging system of claim 11 further comprising a diode to prevent a pull up voltage from changing when a load is being powered.

13. The supercapacitor bank and charging system of claim 10 further comprising a current sensor detecting switching of a load between on and off.

14. The supercapacitor bank and charging system of claim 10 further comprising an alternate ground path used for sensing.

15. The supercapacitor bank and charging system of claim 10 wherein said alternate ground path is a high ohm path that senses a load without activating a load.

16. The supercapacitor bank and charging system of claim 10 wherein one or more sensors determine the presence of an external load without identifying a type of load.

17. The supercapacitor bank and charging system of claim 10 wherein said one or more of said sensors are positioned before a high current output terminal of said supercapacitor bank.

18. The supercapacitor bank and charging system of claim 1 further comprising a switchable ground circuit providing a ground path for said supercapacitor charge system when said supercapacitor bank is divided into said at least two supercapacitor bank parts.

19. The supercapacitor bank and charging system of claim 1 wherein said supercapacitor bank separator circuit uses one or more temperature inputs to control opening and closing of said supercapacitor bank separator circuit.

20. The supercapacitor bank and charging system of claim 1 further comprising a balancing circuit.

21. The supercapacitor bank and charging system of claim 20 wherein said balancing circuit is passively adjustable to supercapacitor bank parts being electrically divided and combined.

22. The supercapacitor bank and charging system of claim 20 wherein said balancing circuit is actively adjustable to supercapacitor bank parts being electrically divided and combined.

23. The supercapacitor bank and charging circuit of claim 20 further comprising a microcontroller controlling said balancing circuit based on input signals from said bank separation circuitry.

24. The supercapacitor bank and charging circuit of claim 1 further comprising a microcontroller.

25. The supercapacitor bank and charging circuit of claim 24 wherein said microcontroller sends an output signal to a digital potentiometer circuit to adjust one or more of voltage output and current output to said at least two or more supercapacitor bank parts of said supercapacitor charge system.

26. The supercapacitor bank and charging circuit of claim 24 wherein said microcontroller uses one or more of a resistor ladder and a network to adjust one or more of voltage output and current output to output of the charging circuits output that charge a supercapacitor bank that has a bank separator that can separate the main bank in to smaller banks for charging.

27. The supercapacitor bank and charging circuit of claim 24 wherein said microcontroller receives at least one input signal from a sensor electrically coupled to said supercapacitor bank and wherein said microcontroller effectuates said bank separator circuit to alternately divide said supercapacitor bank into supercapacitor bank parts and combine said supercapacitor bank parts into a supercapacitor bank.

28. The supercapacitor bank and charging circuit of claim 24 wherein said microcontroller receives at least one input signal from a sensor electrically coupled to said supercapacitor bank and wherein said microcontroller effectuates said supercapacitor charge system to output variable levels of current to one or more supercapacitor bank parts for optimizing charging rates.

29. The supercapacitor bank and charging system of claim 1 further comprising a circuit monitoring one or more of voltage and current of a supercapacitor bank part for triggering said supercapacitor charge system to add a charging current to said supercapacitor bank part thereby charging said supercapacitor bank.

30. The supercapacitor bank and charging system of claim 1 further comprising a circuit monitoring one or more of voltage and current of a supercapacitor bank part for triggering said supercapacitor charge system to add a boosting current to said supercapacitor bank part thereby boosting said supercapacitor bank when said supercapacitor bank is discharging to a load.

31. The supercapacitor bank and charging system of claim 1 wherein said supercapacitor bank separator circuit further comprises a high ohm path across said supercapacitor bank separator for testing voltage levels of said supercapacitor bank.

32. The supercapacitor bank and charging system of claim 1 wherein said high ohm path is switchable between an on and off position for sensing and testing.
